(19) United States
(12) Patent Application Publication
(10) Pub. No.: US 2007/0177100 A1
(43) Pub. Date: Aug. 2, 2007

(54) PHOTOCHROMIC OPITCAL ELEMENT

(75) Inventor: Carol L. Knox, Monroeville, PA (US)

Correspondence Address: Deborah M. Altman;PPG Industries, Inc., Law Department - Intellectual Property, One PPG Place - 39th Floor, Pittsburgh, PA, 15272-0001, US

(73) Assignee: TRANSITIONS OPTICAL, INC., Pinella Park, FL (US)

(21) Appl. No.: 11/684,132

(22) Filed: Mar. 9, 2007

Related U.S. Application Data
(63) Continuation of application No. 11/016,573, filed on Dec. 17, 2004.
(60) Provisional application No. 60/540,873, filed on Jan. 30, 2004.

(51) Int. Cl. G02C 7/02

(52) U.S. Cl. 351/163; 351/166; 351/177

(57) ABSTRACT

Described are optical elements made of a substrate having connected thereto an at least partial film of photochromic adhesive and an at least partial film of a polymeric organic material. Also described are optical elements made of a substrate having connected thereto an at least partial superstrate of a sealed photochromic composite of a film of a first polymeric organic material and a film of a second polymeric organic material having an at least partial film of a photochromic adhesive placed between the films of first and second polymeric organic materials. Methods to prepare the optical elements are also described.

### CROSS-REFERENCE TO RELATED APPLICATIONS

This application is a continuation of U.S. patent application Ser. No. 11/016,573, filed Dec. 17, 2004, which claims the benefit of priority of U.S. Provisional Application Ser. No. 60/540,873, filed on Jan. 30, 2004.

### BACKGROUND OF THE INVENTION

The present invention relates to optical elements demonstrating photochromic properties and ways for producing such elements. More particularly, this invention relates to photochromic optical elements prepared using polymeric films, photochromic materials, adhesives and various substrates.

Optical elements that provide acceptable imaging qualities while reducing the transmission of incident light into the eye are needed for a variety of applications, such as sunglasses, fashion lenses, non-prescription and prescription lenses, sport masks, face shields and goggles. Responsive to that need, photochromic articles used for optical applications have been given considerable attention.

When exposed to light radiation containing ultraviolet rays, such as the ultraviolet radiation in sunlight or the light of a mercury lamp, many photochromic materials exhibit a reversible change in color. When the ultraviolet radiation is discontinued, such a photochromic material will return to its original color or colorless state.

Although photochromic optical elements and methods for producing such elements are known, alternative optical elements and methods for production are sought. There is also a commercial need for methods to produce photochromic optical elements in a rapid and economical manner.

### DESCRIPTION OF THE INVENTION

It is noted that, as used in this specification and the appended claims, the singular forms “a,” “an,” and “the” include plural referents unless expressly and unequivocally limited to one referent.

For the purposes of this specification, unless otherwise indicated, all numbers expressing quantities of ingredients, reaction conditions, and other parameters used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The present invention includes various non-limiting embodiments. In one such non-limiting embodiment, the optical element comprises:

a) a substrate;

b) an at least partial film of a photochromic adhesive comprising an at least partially adhesive material adapted to be thermoplastic and a photochromic amount of a photochromic material; and

c) an at least partial film of a polymeric organic material, e.g., the first polymeric organic material, connected to said film of photochromic adhesive.

In another non-limiting embodiment, the optical element further comprises an at least partial film of a second polymeric organic material, which is the same or different from the first polymeric organic material, interposed between the substrate and the partial film of photochromic adhesive, thereby to form an at least partial superstrate of a photochromic composite comprising the photochromic adhesive interposed between the films of first and second polymeric organic materials. In a further non-limiting embodiment, the photochromic adhesive further comprises an at least partially adhesive material adapted to be thermosetting and a mixture of the adhesive materials adapted to be thermosetting and thermoplastic. In a still further non-limiting embodiment, an at least partially adhesive material may be interposed between the substrate and the superstrate of the photochromic composite.

The phrase “an at least partial film” means an amount of film covering from a portion to the complete surface of the substrate. As used herein, a “film” may be formed by a sheeting type of material or a coating type of material. For example, in one non-limiting embodiment, a film may be an at least partially cured polymeric sheet or an at least partially cured polymeric coating of the material indicated. The phrase “at least partially cured” means a material in which from some to all of the curable or cross-linkable components are cured, crosslinked and/or reacted. In another non-limiting embodiments of the present invention, the films of photochromic adhesive and polymeric organic materials used to produce the optical elements may be chosen from at least partially cured coatings, at least partially cured sheet materials or a combination thereof. For example, in one non-limiting embodiment, a film of photochromic adhesive may be applied to the substrate as an at least partially cured coating and a film of polymeric organic material may be applied as an at least partially cured sheet of polymeric organic material.

The phrase “an at least partially adhesive material” means a material capable of at least partially adhering two surfaces. In one non-limiting embodiment of the present invention, the proportion of the two surfaces adhering due to the at least partially adhesive material, may vary widely, from at least a portion to 100% of the two surfaces joined by the partially adhesive material. The phrase “connected to” means to link together or place in relationship either directly, or indirectly by one or more intervening materials.

An adhesive that is “adapted to be thermoplastic” is an adhesive that softens when exposed to thermal energy and returns to its original condition when cooled to room temperature. The phrase “substantially thermoplastic” means that the adhesive is a thermoplastic material that can comprise some amount of crosslinking. In one non-limiting embodiment, a substantially thermoplastic material is one that has been chain extended with a suitable chain extending material such as, for example, a polyol or diacrylate or otherwise partially crosslinked, with the proviso that the substantially thermoplastic adhesive still retains the aforementioned thermoplastic behavior and does not irreversibly solidify. In another non-limiting embodiment, when a thermoplastic adhesive comprises some crosslinking and is a substantially thermoplastic adhesive material, the reversible process may require more thermal energy or take longer. Whereas, an adhesive that is “adapted to be thermosetting” is an adhesive that is generally cured by a chemical reaction and solidifies irreversibly.

The term “photochromic amount” means that a sufficient amount of photochromic material is used to produce a photochromic effect discernible to the naked eye upon activation. The particular amount used depends often upon the intensity of color desired upon irradiation thereof and upon the method used to incorporate the photochromic materials. Typically, in another non-limiting embodiment, the more photochromic incorporated, the greater is the color intensity up to a certain limit. There is a point after which the addition of any more material will not have a noticeable effect, although more material can be added, if desired.

The phrase “an at least partial superstrate of a photochromic composite” means that the amount of superstrate of photochromic composite connected to the substrate is an amount covering from a portion to the complete surface of the substrate. The term “superstrate” refers to the photochromic composite connected to the substrate by being positioned upon the substrate. In one non-limiting embodiment, the superstrate may be positioned upon the substrate by having the substrate formed behind the photochromic composite in a mold for an optical element. An example of what “connected to” means is that, in one non-limiting embodiment, the superstrate of the photochromic composite may be connected to the substrate through intervening films such as an at least partially adhesive material interposed between the substrate and photochromic composite. In another non-limiting embodiment, the superstrate of the photochromic composite may be superjacent to the substrate, i.e., positioned directly upon the substrate without an intervening film. In relation to the first and second polymeric organic materials of the photochromic composite, the phrase “which is the same or different from “means that the second polymeric organic material may be composed of the same or a different polymeric organic material than the first one.

Non-limiting examples of the aforementioned thermoplastic adhesives which also includes substantially thermoplastic adhesives may be chosen from: hotmelt adhesives, plastisol adhesives, heat-sealing adhesives, high-frequency sensitive heat-sealing adhesives, contact cements, pressure sensitive adhesives, aqueous emulsion adhesives, multi-purpose adhesives, solvent adhesives and mixtures thereof. In a further non-limiting embodiment, the thermoplastic adhesive is a substantially thermoplastic adhesive and is chosen from: hotmelt adhesives, contact cements, pressure sensitive adhesives, aqueous emulsion adhesives and mixtures thereof.

In one non-limiting embodiment, wherein the at least partially adhesive material is a pressure sensitive adhesive adapted to be a substantially thermoplastic adhesive, the pressure sensitive adhesive comprises an olefinic polymer. In a further non-limiting embodiment, the olefinic polymer comprises homopolymers, copolymers, block polymers and mixtures thereof. In a still further non-limiting embodiment, the olefinic polymer comprises less than 1 percent by weight of free monomer based on the total weight, of the olefinic polymer. Non-limiting examples of monomers used to produce the aforementioned olefinic polymer include acrylic acid, methacrylic acid, acrylate and methacrylate esters in which the ester part comprises up to 8 carbon atoms or that comprise copolymers of the aforementioned monomers with vinyl acetate or styrene.

In alternate non-limiting embodiments, the pressure sensitive adhesive comprises olefinic polymers wherein the amount of free monomers is less than 0.1 percent, less than 0.01 percent or less than 0.001 percent by weight. The amount of free residual monomer may range between any of the aforestated values, inclusive of the recited values. In a further non-limiting embodiment, the olefinic polymer is a copolymer comprising 2-ethylhexylacrylate and vinyl acetate. Non-limiting examples of pressure sensitive adhesives which are substantially thermoplastic adhesives include DuroTak® 1095 reported to be an acrylic solution pressure sensitive adhesive having a viscosity of 2500 cps; DuroTak® 1057 reported to be an acrylic solution pressure sensitive adhesive having a viscosity of 1000 cps and DuroTak® 1194 reported to be an acrylic solution pressure sensitive adhesive having a viscosity of 3000 cps, all available from National Starch & Chemical.

In one non-limiting embodiment, adhesives in which the content of free monomers is less than 1 percent by weight can be prepared by the hydrogenation of the adhesive in an organic solvent in the presence of a heterogeneous or homogeneous catalyst after the completion of the polymerization or copolymerization of the polymer. See U.S. Pat. No. 5,990,229, column 2, line 6 to column 9, line 34, which disclosure related to the hydrogenation of the adhesive to reduce free monomer content is incorporated herein by reference.

In another non-limiting embodiment, the partially adhesive materials used in the photochromic composite may include any type of adhesive material suitable for optical elements known to those skilled in the art. Non-limiting examples of adhesives are described in “Adhesives”, Ullmann's Encyclopedia of Industrial Chemistry, Fifth Edition, 1985, Volume A1, pages 221-267, which disclosure is incorporated herein by reference. In a further non-limiting embodiment the adhesive material is chosen from thermoplastic adhesives, thermosetting adhesives and mixtures thereof. Suitable adhesives include those based on the setting mechanisms of “Setting without a Chemical Reaction” and “Setting by a Chemical Reaction” described in the aforementioned Ullmann's Encyclopedia of Industrial Chemistry. As used herein “setting” means the solidification of the adhesive by physical or chemical processes.

Non-limiting examples of suitable thermoplastic adhesives for the photochromic composite were described hereinbefore. Non-limiting examples of thermosetting adhesives may be chosen from two-component adhesives based on unsaturated polyesters and (meth)acrylates, i.e., acrylates and methacrylates; one-component adhesives based on cyanoacrylates and methacrylates; polyaddition adhesives based on epoxy resins and reactive polyurethanes; and polycondensation adhesives based on polyhydroxy containing materials, polyimides, polybenzimidazoles and silanols. In another non-limiting embodiment, the thermosetting adhesive is chosen from two-component adhesives based on unsaturated polyesters and (meth)acrylates.

In a still further non-limiting embodiment, the adhesive for the photochromic composite is chosen from thermoplastic adhesives and is a pressure sensitive adhesive adapted to be substantially thermoplastic. The film of photochromic adhesive used in the photochromic composite and other embodiments of the present invention, has a thickness that may vary widely. Non-limiting examples include a thickness that may range from 0.1 mil to 40 mils and any range of thicknesses between these values, inclusive of the recited values. However, if desired, greater thicknesses may be used.

In one non-limiting embodiment, the types of material used for the film of polymeric organic material, e.g., films of the first and/or second polymeric organic materials, may vary widely and be chosen from the polymeric organic materials of the substrate and the protective films described hereinafter. The thickness of the films of polymeric organic materials may vary widely. Non-limiting examples include a thickness that may range from 0.1 mil to 40 mils and any range of thicknesses between these values, inclusive of the recited values. However, if desired, greater thicknesses may be used.

The thickness of the photochromic composite may also vary widely. Non-limiting examples include a thickness that may range from 0.3 mil to 120 mils and any range of thicknesses between these values, inclusive of the recited values. However, if desired, greater thicknesses may be used.

The partially adhesive material used to connect the photochromic composite to the substrate may be chosen from any type of adhesive suitable for optical elements, known to those skilled in the art, e.g., thermoplastic adhesives, thermosetting adhesives and mixtures thereof. Non-limiting examples of suitable adhesives are disclosed in U.S. Patent Publication 2004/0096666 in paragraph [0127], which disclosure of such adhesives is incorporated herein by reference. In one non-limiting embodiment, thermosetting adhesives are used to connect the composite to the substrate. In another non-limiting embodiment, the thermosetting adhesive is chosen from two-component adhesives based on unsaturated polyesters and (meth)acrylates. In another non-limiting embodiment, the adhesive material used to connect the photochromic composite to the substrate is a thermosetting adhesive chosen from one-component adhesives based on cyanoacrylates. Non-limiting examples of thermosetting adhesives of one-component adhesives based on cyanoacrylates include adhesives such as Sicomet Power Series F-15 reported to be an ethylester cyanoacrylate available from HENKEL Adhesives Corporation.

A wide variety of photochromic materials may be used in the photochromic adhesive of the present invention. In one non-limiting embodiment, the photochromic material is chosen from an inorganic photochromic material, an organic photochromic material and mixtures thereof.

In alternate non-limiting embodiments, the photochromic materials described hereinafter may be provided in a variety of different forms. Non-limiting examples include: a single photochromic compound; a mixture of photochromic compounds; a material comprising a photochromic compound, such as a monomeric or polymeric ungelled solution; a material such as a monomer or polymer to which a photochromic compound is chemically bonded; a material comprising and/or having chemically bonded to it a photochromic compound, the outer surface of the material being encapsulated (encapsulation is a form of coating), for example with a polymeric resin or a protective coating such as a metal oxide that prevents contact of the photochromic material with external materials such as oxygen, moisture and/or chemicals that have a negative effect on the photochromic material, such materials can be formed into a particulate prior to applying the protective coating as described in U.S. Pat. Nos. 4,166,043 and 4,367,170; a photochromic polymer, e.g., a photochromic polymer comprising photochromic compounds bonded together; or mixtures thereof.

In one non-limiting embodiment, the inorganic photochromic material contains crystallites of silver halide, cadmium halide and/or copper halide. Other non-limiting inorganic photochromic materials may be prepared by the addition of europium (II) and/or cerium(III) to a mineral glass such as a soda-silica glass. In another non-limiting embodiment, the inorganic photochromic materials are added to molten glass and formed into particles that are incorporated into the photochromic adhesive. Such inorganic photochromic materials are described in Kirk Othmer Encyclopedia of Chemical Technology, 4th Edition, Volume 6, pages 322-325, which disclosure is incorporated herein by reference.

In another non-limiting embodiment, the photochromic material is an organic photochromic material comprising an activated absorption maxima in the range from 300 to 1000 nanometers. In one non-limiting embodiment, the organic photochromic material comprises a mixture of (a) an organic photochromic material having a visible lambda max of from 400 to less than 550 nanometers, and (b) an organic photochromic material having a visible lambda max of from 550 to 700 nanometers.

In a further non-limiting embodiment, the photochromic material is an organic photochromic material that may be chosen from pyrans, oxazines, fulgides, fulgimides, diarylethenes and mixtures thereof.

Non-limiting examples of photochromic pyrans that may be used herein include benzopyrans, and naphthopyrans, e.g., naphtho[1,2-b]pyrans, naphtho[2,1-b]pyrans, indeno-fused naphthopyrans and heterocyclic-fused naphthopyrans, spiro-9-fluoreno[1,2-b]pyrans, phenanthropyrans, quinolinopyrans; fluoroanthenopyrans and spiropyrans, e.g., spiro(benzindoline)naphthopyrans, spiro(indoline)benzopyrans, spiro(indoline)naphthopyrans, spiro(indoline)quinolinopyrans and spiro(indoline)pyrans and mixtures thereof. Non-limiting examples of benzopyrans and naphthopyrans are disclosed in U.S. Pat. No. 5,645,767 at column 2, line 16 to column 12, line 57; U.S. Pat. No. 5,723,072 at column 2, line 27 to column 15, line 55; U.S. Pat. No. 5,698,141 at column 2, line 11 to column 19, line 45; U.S. Pat. No. 6,022,497 at column 2, line 21 to column 11, line 46; U.S. Pat. No. 6,080,338 at column 2, line 21 to column 14, line 43; U.S. Pat. No. 6,136,968 at column 2, line 43 to column 20, line 67; U.S. Pat. No. 6,153,126 at column 2, line 26 to column 8, line 60; U.S. Pat. No. 6,296,785 at column 2, line 47 to column 31, line 5; U.S. Pat. No. 6,348,604 at column 3, line 26 to column 17, line 15; U.S. Pat. No. 6,353,102 at column 1, line 62 to column 11, line 64; U.S. Pat. No. 6,630,597 at column 2, line 16 to column 16, line 23; and U.S. Pat. No. 6,736,998 at column 2, line 53 to column 19, line 7 which disclosures are incorporated herein by reference, Further non-limiting examples of naphthopyrans and complementary organic photochromic substances are described in U.S. Pat. No. 5,658,501 at column 1, line 64 to column 13, line 17, which disclosure is incorporated herein by reference. Spiro(indoline)pyrans are also described in the text, Techniques in Chemistry, Volume III, “Photochromism”, Chapter 3, Glenn H. Brown, Editor, John Wiley and Sons, Inc., New York, 1971, which is also incorporated herein by reference.

Non-limiting examples of photochromic oxazines that may be used in conjunction with various non-limiting embodiments disclosed herein include benzoxazines, naphthoxazines, and spiro-oxazines, e.g., spiro(indoline)naphthoxazines, spiro(indoline)pyridobenzoxazines, spiro(benzindoline)pyridobenzoxazines, spiro(benzindoline)naphthoxazines, spiro(indoline)benzoxazines, spiro(indoline)fluoranthenoxazine, spiro(indoline)quinoxazine and mixtures thereof.

Non-limiting examples of photochromic fulgides or fulgimides that may be used in conjunction with various non-limiting embodiments disclosed herein include: fulgides and fulgimides, which are disclosed in U.S. Pat. No. 4,685,783 at column 1, line 57 to column 5, line 27, and in U.S. Pat. No. 4,931,220 at column 1, line 39 through column 22, line 41, the disclosure of such fulgides and fulgimides are incorporated herein by reference. Non-limiting examples of diarylethenes are disclosed in U.S. Patent Application 2003/0174560 paragraphs [0025] to [0086] which disclosure related to diarylethenes is incorporated herein by reference.

In one non-limiting embodiment, polymerizable organic photochromic materials, such as polymerizable naphthoxazines disclosed in U.S. Pat. No. 5,166,345 at column 3, line 36 to column 14, line 3; polymerizable spirobenzopyrans disclosed in U.S. Pat. No. 5,236,958 at column 1, line 45 to column 6, line 65; polymerizable spirobenzopyrans and spirobenzothiopyrans disclosed in U.S. Pat. No. 5,252,742 at column 1, line 45 to column 6, line 65; polymerizable fulgides disclosed in U.S. Pat. No. 5,359,085 at column 5, line 25 to column 19, line 55; polymerizable naphthacenediones disclosed in U.S. Pat. No. 5,488,119 at column 1, line 29 to column 7, line 65; polymerizable spirooxazines disclosed in U.S. Pat. No. 5,821,287 at column 3, line 5 to column 11, line 39; polymerizable polyalkoxylated naphthopyrans disclosed in U.S. Pat. No. 6,113,814 at column 2, line 23 to column 23, line 29; and the polymeric matrix compatibilized naphthopyran of U.S. Pat. No. 6,555,028 at column 2, line 40 to column 24, line 56 may be used. The disclosures of the aforementioned patents on polymerizable organic photochromic materials are incorporated herein by reference.

The photochromic materials can be incorporated into the adhesive by various means. In a series of non-limiting embodiments, the photochromic materials may be incorporated, e.g., dissolved and/or dispersed, into the adhesive, or polymerized with other components of the adhesive. Alternatively, the photochromic materials may be incorporated into the photochromic adhesive by imbibition, permeation or other transfer methods as known by those skilled in the art.

In one non-limiting embodiment, the photochromic adhesive comprises a photochromic amount of a photochromic material. In another non-limiting embodiment, the amount of photochromic material incorporated into the adhesive may range from 0.1 to 90 weight percent based on the weight of the solids in the adhesive. In alternate non-limiting embodiments, the amount of photochromic material ranges from 0.1 to 80 weight percent, from 1 to 50 weight percent, from 5 to 40 weight percent, or from 7 to 20 weight percent. The amount of photochromic material in the photochromic adhesive may range between any combination of these values, inclusive of the recited range.

In a further non-limiting embodiment, compatible (chemically and color-wise) fixed tint dyes may be added or applied to the substrate, polymeric films, protective films and/or photochromic adhesive, used to produce the photochromic optical element to achieve a more aesthetic result, for medical reasons, or for reasons of fashion. In one non-limiting embodiment, the dye may be selected to complement the color resulting from the activated photochromic materials, e.g., to achieve a more neutral color or absorb a particular wavelength of incident light. In another non-limiting embodiment, the dye may be selected to provide a desired hue to the host material when the photochromic materials are in an unactivated state.

In a still further non-limiting embodiment, the aforementioned fixed tint dyes may be associated with the protective films described hereinafter used with the optical elements of the present invention as known to those skilled in the art. See for example, U.S. Pat. No. 6,042,737 at column 4, line 43 to column 5, line 8, which disclosure related to tinting coated substrates is incorporated herein by reference.

In various non-limiting embodiments, adjuvant materials may also be incorporated into the photochromic adhesive. Such adjuvants may be incorporated prior to, simultaneously with or subsequent to application or incorporation of the photochromic material. For example, in one non-limiting embodiment, ultraviolet light absorbers may be admixed with photochromic materials before their addition to the composition or such absorbers may be superposed, e.g., superimposed, as a coating or film between the photochromic adhesive and the incident light.

In addition to ultraviolet light stabilizers, other adjuvants, such as, stabilizers may be used to improve the light fatigue resistance of the photochromic materials. Non-limiting examples of stabilizers include hindered amine light stabilizers (HALS), asymmetric diaryloxalamide (oxanilides) compounds and singlet oxygen quenchers, e.g., a nickel ion complex with an organic ligand, polyphenolic antioxidants and mixtures of such stabilizers are contemplated. In one non-limiting embodiment, the aforementioned adjuvants may be used in the photochromic adhesive individually and as a mixture, e.g., of stabilizers in combination with ultraviolet light absorbers, as known to those skilled in the art.

In another non-limiting embodiment, further adjuvant materials can be incorporated into the photochromic adhesive composition of the present invention, e.g., conventional ingredients that aid in processing or impart desired characteristics to the resulting optical elements. Non-limiting examples of such ingredients include solvents, e.g, aqueous and/or organic solvents, rheology control agents, surfactants, initiators, catalysts, cure-inhibiting agents, reducing agents, acids, bases, preservatives, crosslinking materials, free radical donors, free radical scavengers and thermal stabilizers, which adjuvant materials are known to those skilled in the art.

In one non-limiting embodiment, the substrate is chosen from mineral glass, ceramic, e.g., solgel, and polymeric organic materials and is an optical element, e.g., ophthalmic articles such as plano and vision correcting ophthalmic lenses and ocular lenses that physically reside in or on the eye, e.g., contact lenses and intraocular lenses. In another non-limiting embodiment, the optical element is chosen from windows and vehicular transparencies such as automobile windshields and side windows. In a further non-limiting embodiment, the substrate may be rigid, e.g., capable of maintaining its shape and supporting the connected photochromic adhesive and polymeric film or photochromic superstrate. In a still further non-limiting embodiment of the present invention the substrate is a polymeric organic material such as an optically clear polymerizate, e.g., material suitable for optical applications, such as ophthalmic articles. Such optically clear polymerizates have a refractive index that may vary widely. Examples of non-limiting embodiments include polymerizates of optical resins such as thermoplastic polycarbonate and optical resins sold by PPG Industries, Inc. as TRIVEX® monomer composition and under the CR-designation, e.g., CR-39® monomer composition. Non-limiting examples of suitable substrates are disclosed in U.S. Patent Publication 2004/0096666 in paragraphs [0061] and [0064] to [0081] which disclosure of suitable substrates is incorporated herein by reference.

In another non-limiting embodiment, the polymeric organic material used as the substrate of the present invention comprises polymeric organic material chosen from thermoplastic material, thermosetting material and mixtures thereof. In another non-limiting embodiment, such materials are described in the Kirk-Othmer Encyclopedia of Chemical Technology, Fourth Edition, Volume 6, pages 669 to 760, which disclosure is incorporated herein by reference. In a further non-limiting embodiment, thermoplastic materials can be made substantially thermoplastic or thermosetting by the appropriate chemical modification, as known to those skilled in the art.

Further non-limiting examples of optical resins that may be used as substrates in the present invention include the resins used to form hard and soft contact lenses disclosed in U.S. Pat. No. 5,166,345, column 11, line 52, to column 12, line 52, soft contact lenses with high moisture content described in U.S. Pat. No. 5,965,630 and extended wear contact lenses described in U.S. Pat. No. 5,965,631, which disclosures related to optical resins for contact lenses are incorporated herein by reference.

As previously mentioned, the types of polymeric organic materials used to make the films of the first and/or second polymeric organic materials described herein can vary widely. In one non-limiting embodiment, the polymeric organic materials may be chosen from thermosetting materials, thermoplastic materials and mixtures thereof. In another non-limiting embodiment, such materials include the polymeric organic materials chosen for the substrate as well as the protective films, e.g., the radiation cured (meth)acrylate based coating used as the protective gradient film described hereinafter. Non-limiting examples of films of polymeric organic materials are disclosed in U.S. Patent Publication 2004/0096666 in paragraphs [0082] to [0098] which disclosure of such polymeric films is incorporated herein by reference.

In another non-limiting embodiment, the films of the present invention are thermoplastic polymeric organic materials chosen from nylon, poly(vinyl acetate), vinyl chloride-vinyl acetate copolymer, poly (C₁-C₈ alkyl) acrylates, poly (C₁-C₈ alkyl) methacrylates, styrene-butadiene copolymer resin, poly(urea-urethanes), polyurethanes, polyterephthalates, polycarbonates, polycarbonate-silicone copolymer and mixtures thereof.

In a series of non-limiting embodiments, the optical elements of the present invention may further comprise surface treatments, known to those skilled in the art, connected to at least a portion of the substrate, e.g., a lens, as described hereinafter. Non-limiting examples include protective films, at least partially polarizing surface treatments and combinations thereof. In another non-limiting embodiment, the optical elements comprising the aforementioned surface treatments further comprise an at least partially antireflective surface treatment, an at least partially hydrophobic surface treatment or sequential surface treatments of the antireflective and hydrophobic treatments superjacent to at least a portion of the surface of the optical element. In one non-limiting embodiment of such a sequential treatment, the antireflective treatment is applied first to the surface of the optical element followed by the hydrophobic treatment.

In one non-limiting embodiment, a protective film is typically connected to a substrate to prevent scratches from the effects of friction and abrasion. As described hereinbefore, in an alternate non-limiting embodiment, the protective film may serve as a film of the polymeric organic material connected to the photochromic adhesive or used as the films to form the superstrate of the photochromic composite. The protective film connected to the optical element of the present invention, in a further non-limiting embodiment, is an at least partially abrasion resistant film. The phrase “an at least partially abrasion resistant film” refers to an at least partial film of an at least partially cured coating or sheet of a protective polymeric material that demonstrates a resistance to abrasion that is greater than the standard reference material, typically a plastic made of CR-39® monomer available from PPG Industries, Inc, as tested in a method comparable to ASTM F-735 Standard Test Method for Abrasion Resistance of Transparent Plastics and Coatings Using the Oscillating Sand Method.

In one non-limiting embodiment, the protective film may be connected to an at least partial film of a polymeric organic material. In a another non-limiting embodiment, the protective film may be superjacent to the film of a polymeric organic material. In a further non-limiting embodiments, the protective film may be chosen from protective sheet materials, protective gradient films (which also provide a gradient in hardness for the films between which they are interposed), protective coatings and combinations thereof. Protective coatings such as hardcoats may be applied onto the surface of the polymeric film, the substrate and/or any applied films, e.g., superjacent to protective transitional films.

In one non-limiting embodiment, when the protective film is chosen from protective sheet materials, it may be chosen from the same materials used for the aforementioned polymeric film provided that the material functions as intended, i.e., to protect the film to which it is connected. Non-limiting examples of protective polymeric sheet materials are disclosed in paragraphs [0118] to [0126] of U.S. Patent Publication 2004/0096666, which disclosure of protective polymeric films are incorporated herein by reference.

The protective gradient films provide an at least partially abrasion resistant film and may be subsequently coated with another protective film. In one non-limiting embodiment, the protective gradient film may serve to protect the article during shipping or subsequent handling prior to the application of the additional protective film. After application of an additional protective film, the protective gradient film provides a gradient in hardness from one applied film to another. For example, in one non-limiting embodiment, such a protective gradient film may be interposed between a relatively soft film of a polymeric organic material or a photochromic adhesive and a relatively hard polymeric protective film on the outermost surface of the optical element. The hardness of such films may be determined by methods known to those skilled in the art. In another non-limiting embodiment, a protective film is superjacent to a protective gradient film. Non-limiting examples of protective films providing such gradient properties include the radiation cured (meth)acrylate-based coatings described in U.S. Patent Application Publication 2003/0165686 in paragraphs [0010] to [0023] and [0079] to [0173], which disclosure of radiation-cured (meth)acrylate-based coatings is incorporated herein by reference.

In a further non-limiting embodiment, the protective films include protective coatings. Non-limiting examples of protective coatings known in the art that provide abrasion and scratch resistance are chosen from polyfunctional acrylic hard coatings, melamine-based hard coatings, urethane-based hard coatings, alkyd-based coatings and organosilane type coatings. In the present invention, films prepared using all of the aforementioned hard coatings including the organosilanes are defined herein as being films of polymeric organic materials. In one non-limiting embodiment, the protective coating that provides abrasion and scratch resistance comprises an organosilane type hard coating. Non-limiting examples of such abrasion resistant coatings are disclosed in U.S. Patent Application 2004/0096666 in paragraphs [0128] to [0149], which disclosure related to abrasion resistant coatings is incorporated herein by reference.

In one non-limiting embodiment, the protective film is an organosilane type coating superjacent to a protective gradient film which is a radiation-cured (meth)acrylate-basic coating applied to a film of photochromic adhesive applied to a lens to form the optical element of the present invention.

In another non-limiting embodiment, the protective film may be connected to the surface of the optical element of the present invention with or without an at least partially adhesive material. If the adhesive material is present, it may be any type of adhesive known to those skilled in the art. In a further non-limiting embodiment, the at least partially adhesive material is chosen from a thermoplastic adhesive, thermosetting adhesive and a mixture thereof.

In a further non-limiting embodiment, the protective films used in the optical elements of the present invention have a thickness that may vary widely. Non-limiting examples include a thickness that may range from 0.1 mil to 40 mils and any range of thicknesses between these values, inclusive of the recited values. However, if desired, greater thicknesses may be used.

In one non-limiting embodiment, the optical element of the present invention further comprises an at least partially polarizing surface treatment. The phrase “at least partially polarizing” means that from some to all of the vibrations of the electric field vector of lightwaves is confined to one direction or plane by the surface treatment. Such a surface treatment may be applied to the optical element as a film having an aligned dichroic material to at least partially polarize transmitted radiation. In one non-limiting embodiment, a polymeric sheet is stretched to align the dichroic material applied to the polymeric sheet. In another non-limiting embodiment, a coating is cured in a directional fashion, e.g., using polarized ultraviolet radiation, to align the dichroic materials in the coating.

In another non-limiting embodiment, the optical element further comprises an at least partially antireflective surface treatment. The phrase “an at least partially antireflective surface” treatment means that there is an at least partial improvement in the antireflective nature of the optical element to which it is applied. In non-limiting embodiments, there may be a reduction in the amount of glare reflected by the surface of the treated optical element and/or an increase in the percent transmittance through the treated optical element as compared to an untreated optical element.

In one non-limiting embodiment, the process of preparing an antireflective surface may be by producing a graded porosity in a cured coating composition of an acid catalyzed hydrolysis and condensation products of a water-silane monomer mixture and a film forming amount of a polymer as described in U.S. Pat. No. 5,580,819 at column 2, line 50 to column 23, line 46, which disclosure related to antireflective coatings is incorporated herein by reference.

In another non-limiting embodiment, an at least partially antireflective surface treatment, e.g., a monolayer or multilayer of metal oxides, metal fluorides, or other such materials, can be connected to the polymeric film surface of the optical elements, e.g., lenses, of the present invention through vacuum evaporation, sputtering, or some other method.

In a further non-limiting embodiment, the optical element of the present invention further comprises an at least partially hydrophobic surface treatment. The phrase “an at least partially hydrophobic surface” is a film that at least partially improves the water repellent nature of the substrate to which it is applied by reducing the amount of water from the surface that can adhere to the substrate as compared to an untreated substrate.

In one non-limiting embodiment, a hydrophobic material such as a fluorinated organosilane material, can be applied to the surface of the optical element to provide an at least partially hydrophobic surface. Alternatively, during the aforedescribed anti-reflective deposition process, a final deposition of metal oxides, metal fluorides or other such materials can be used to provide a hydrophobic surface treatment to the anti-reflective surface treatment.

The optical elements of the present invention may be produced by a variety of non-limiting methods. In one non-limiting embodiment, a method for forming an optical element of the present invention comprises:

a) providing a substrate;

b) connecting an at least partial film of a photochromic adhesive comprising an at least partially adhesive material adapted to be thermoplastic and a photochromic amount of a photochromic material to a surface of said substrate; and

c) connecting an at least partial film of a first polymeric organic material to said photochromic adhesive under conditions such that the film of the first polymeric organic material is at least partially adhesive to said surface of the substrate.

The process of connecting an at least partial film of a photochromic adhesive to the substrate when said adhesive is a coating may be by any of the methods used in coating technology and used in the application of pressure sensitive adhesives. Non-limiting examples include, spray coating, spin coating, spin and spray coating, spread coating, curtain coating, dip coating, casting-coating, roll-coating, reverse roll coating, transfer roll coating, kiss/squeeze coating, gravure roll coating, slot-die coating, blade coating, knife coating, and rod/bar coating. In one non-limiting embodiment, the slot-die coating method is used. A description of coating processes used for the application of pressure sensitive adhesives is disclosed in Chapter 38. Coating Equipment of the Handbook of Pressure Sensitive Adhesive Technology, 3^{rd} Edition, Satas & Associates, 1999, pages 896 to 936, which disclosure is incorporated herein by reference.

In one non-limiting embodiment, a temporary substrate such as a paper or polymeric film to which a release coating has been applied, may be applied to the photochromic adhesive coated substrate and removed prior to the application of the film of the first polymeric organic material.

In an alternate non-limiting embodiment, the aforementioned method comprises connecting the partial film of photochromic adhesive to the surface of the at least partial film of polymeric organic material and connecting the resulting assembly of photochromic adhesive and polymeric film to the substrate. In a further non-limiting embodiment, the aforementioned method comprises connecting a temporary substrate to the photochromic adhesive coated surface of the film of the first polymeric organic material. When making the optical element of the present invention, the temporary substrate may be removed and the photochromic adhesive side may be connected to the substrate.

In a further non-limiting embodiment of the aforementioned method, a sheet of photochromic adhesive material may be used. Such a sheet may be prepared by interposing the photochromic adhesive between two temporary substrates having release coatings and transferring the resulting sheet of photochromic adhesive to the substrate by removing the first temporary substrate, connecting the photochromic adhesive side to the substrate surface and removing the second temporary substrate. The photochromic adhesive may be at least partially cured after interposing it between the two temporary substrates in order to form a transferable sheet of the photochromic adhesive. The aforementioned procedures that include temporary substrates, in one non-limiting embodiment, may be used to provide rapid and economical ways to produce the optical elements of the present invention.

Following application of the photochromic adhesive to the surface of the substrate, in one non-limiting embodiment, any solvent used to prepare the photochromic adhesive, e.g., to dissolve the photochromic material in the at least partially adhesive material which may be a polymer, may be evaporated. The evaporation of solvent may be considered an at least partial curing of the photochromic adhesive, for example, by the setting mechanism of setting without a chemical reaction. This may occur before, during and/or after connecting the at least partial film of the first polymeric organic material. In another non-limiting embodiment, when the adhesive is curable by methods other than evaporation of solvent, the adhesive may also be at least partially cured before, during and/or after connecting the at least partial film of the first polymeric organic material to it. This may be accomplished, in one non-limiting embodiment, by exposing a UV-curable adhesive to ultraviolet radiation before, during and/or after the process of connecting the at least partial film to it.

In a still further non-limiting embodiment, the degree of reacted components when at least partially curing the adhesive may vary widely, e.g., from at least a portion to all of the possible curable, crosslinkable and/or reactable components. Non-limiting methods used for curing the photochromic adhesive include solvent evaporation, radical polymerization, thermal polymerization, photopolymerization or a combination thereof. Additional non-limiting methods include irradiating the polymerizable material with infrared, ultraviolet, gamma or electron radiation so as to initiate the polymerization reaction of the polymerizable components. This may be followed by a heating step.

In another non-limiting embodiment of the present invention, a method for forming an optical element comprises:

a) providing a substrate;

b) connecting an at least partial superstrate of a photochromic composite to a surface of said substrate under conditions such that said superstrate of a photochromic composite connects to the selected surface of the substrate, said photochromic composite comprising:
i) an at least partial film of a first polymeric organic material;
ii) an at least partial film of a second polymeric organic material which is the same or different from the first polymeric organic material; and
iii) a photochromic adhesive comprising an at least partially adhesive material and a photochromic amount of a photochromic material interposed between said films of the first and second polymeric organic materials

In a further non-limiting embodiment, the aforementioned method further comprises using an at least partially sealed photochromic composite. As used herein, “at least partially sealed” means that from some to all of the photochromic adhesive interposed between the films of the first and second polymeric organic materials is kept in the photochromic composite and that from some to all of the materials outside of the photochromic composite are kept outside of the composite. In one non-limiting embodiment, the photochromic composite may be at least partially sealed by securing the first polymeric film to the second polymeric film. In another non-limiting embodiment, the edges of the photochromic composite may be at least partially sealed by applying pressure, applying heat and a combination thereof to seal, e.g. by crimping and/or fusing; the films of the first and second polymeric organic materials. The photochromic adhesive within the composite may be, in one non-limiting embodiment, processed, e.g., at least partially cured, in the same manner as described hereinbefore.

One non-limiting embodiment of the aforementioned method further comprises interposing an at least partial film of at least partially adhesive material between the superstrate and the substrate. In another non-limiting embodiment, the superstrate having an adhesive film on one surface is connected to a temporary substrate having a release coating that is removed from the superstrate prior to connecting it to the substrate.

Non-limiting methods that may be used for preparing optical articles of the present invention are disclosed in U.S. Patent Publication 2004/0096666 in paragraphs [0154] to [0157] and [0159], which methods of forming optical elements with multiply laminates are incorporated herein by reference. In one non-limiting embodiment, the photochromic composite of the present invention is a thermo-formable material.

An alternate non-limiting method for producing an optical element of the present invention wherein the method of providing a substrate and connecting a superstrate comprises:

i) providing a photochromic composite described hereinbefore;

ii) providing an optical mold having a first and second surface, said first and second surfaces forming a cavity;

iii) placing said photochromic composite within the optical mold against said first surface of the optical mold, said photochromic composite having a size sufficient to cover a desired portion of the first surface;

iv) introducing polymerizable optical resin capable of forming an optical element into the cavity of the optical mold, and

v) at least partially curing said polymerizable optical resin, thereby to form an optical element having a first surface and a second surface and having the superstrate of a photochromic composite connected to said first surface of said optical element.

Non-limiting methods for producing an optical element of the present invention by the aforementioned process include injection molding, reaction injection molding and casting. One non-limiting method is disclosed in U.S. Patent Publication 2004/0096666 in paragraph [0158] which film insert molding method is incorporated herein by reference. Optical elements of the present invention include those formed by the aforementioned methods. One skilled in the art would appreciate the conditions and parameters, such as temperature, pressure and time, in carrying out the various methods of making optical elements herein and above. See for example U.S. Pat. No. 6,328,446, which is incorporated in toto herein by reference.

In the aforementioned molding methods for forming the optical elements of the present invention, in one non-limiting embodiment, the substrate maybe a pre-formed substrate, e.g., a lens or a preformed optical wafer. In another non-limiting embodiment, an optical preformed wafer may be included in the mold with the photochromic composite. Such an optical wafer may be used to introduce additional functionality, e.g., tint or polarization, and/or serve as a matrix to which the polymerizable optical resin surrounds to form the optical element.

In an alternate non-limiting embodiment, the aforementioned methods further comprise connecting the aforementioned surface treatments to the substrate or optical element. Connecting the aforementioned surface treatments to the substrate may be done during the preparation of the optical elements of the present invention as known to those skilled in the art.

In one non-limiting embodiment, an optical element of the present invention may be prepared by sequentially applying to the substrate an at least partial film of photochromic adhesive, an at least partial film of a polymeric organic material, such as a protective gradient film, and an at least partial film of a protective coating, e.g., an organosilane hardcoat. In another non-limiting embodiment, an antireflective surface may be applied to the aforementioned optical element. In a further non-limiting embodiment, a hydrophobic surface may be applied to the antireflective surface of the aforementioned optical element.

In another non-limiting embodiment, an optical element of the present invention may be prepared by sequentially applying to the substrate an at least partial superstrate of a photochromic composite, an at least partial film of a protective film, e.g., an organosilane hardcoat. In a further non-limiting embodiment, an at least partial film of an at least partially adhesive material is applied to the substrate prior to applying the superstrate. In another non-limiting embodiment, an antireflective surface may be applied to the aforementioned optical element. In a further non-limiting embodiment, a hydrophobic surface may be applied to the antireflective surface of the aforementioned optical element.

Non-limiting examples of optical elements prepared by the various methods disclosed herein include ophthalmic articles such as plano (without optical power) and vision correcting (prescription) lenses (finished and semi-finished) including multifocal lenses (bifocal, trifocal, and progressive lenses); and ocular devices such as contact lenses and interocular lenses, sun lenses, fashion lenses, sport masks, face shields and goggles.

The present invention is more particularly described in the following examples that are intended as illustration only, since numerous modifications and varialtions therein will be apparent to those skilled in the art.

### Photochromic Composition

The following materials were added to a suitable vessel equipped with an agitator and means for heating. The resulting mixture was heated to 60° C. and mixed for one hour and left to cool overnight.

| Material | Weight (grams) |
|---|---|
| Toluene | 36,500 |
| Photochromic 1 ⁽¹⁾ | 1,520 |
| Photochromic 2 ⁽²⁾ | 1,040 |
| Photochromic 3 ⁽³⁾ | 2,080 |
| Photochromic 4 ⁽⁴⁾ | 960 |
| Photochromic 5 ⁽⁵⁾ | 1,200 |
| Photochromic 6 ⁽⁶⁾ | 1,200 |

⁽¹⁾ A photochromic naphtho[1,2-b]pyran that exhibits a purple color when irradiated with ultraviolet light.
⁽²⁾ A photochromic naphtho[1,2-b]pyran that exhibits a blue color when irradiated with ultraviolet light.
⁽³⁾ A photochromic naphtho[1,2-b]pyran that exhibits a yellow-orange color when irradiated with ultraviolet light.
⁽⁴⁾ A photochromic naphtho[1,2-b]pyran that exhibits a yellow-orange color when irradiated with ultraviolet light.
⁽⁵⁾ A photochromic naphtho[1,2-b]pyran that exhibits a green color when irradiated with ultraviolet light.
⁽⁶⁾ A photochromic naphtho[1,2-b]pyran that exhibits a brown color when irradiated with ultraviolet light.

### EXAMPLE 1

The Photochromic Composition (0.04 gram) was added to a vessel containing toluene (0.46 gram). The vessel was equipped with an agitator and means for heating. The mixture was heated to 60° C. and mixed for one hour. The resulting mixture was cooled and added to Adhesive #1 (5.0 grams) which was DuroTak® 1194 pressure sensitive adhesive from National Starch, Inc., and mixing was continued for 20 minutes.

### EXAMPLE 2

The procedure of Example 1 was followed except that Adhesive #2 which was DuroTak® 1057 pressure sensitive adhesive from National Starch, Inc., was used.

### EXAMPLE 3

The procedure of Example 1 was followed except that Adhesive #3 which was DuroTak® 1095 pressure sensitive adhesive from National Starch, Inc., was used.

### EXAMPLE 4

### Part A

Examples 1, 2 and 3 were each applied to individual 10 mil polycarbonate sheets measuring 5.0 inches by 8.0 inches (12.7 cm by 20.3 cm) using a 5 mil draw-down bar. The polycarbonate sheets were obtained from McMaster-Carr and were identified as having a gloss/gloss finish and were cut from original sheets measuring 24.5″×24.25″ (62.2 cm by 62.2 cm). The resulting Example-coated sheets were placed in a 90° C. oven for 15 minutes to evaporate the toluene and were cooled to room temperature (about 23° C.). A second 10 mil polycarbonate sheet was applied to each of the coated surfaces and smoothed to eliminate air bubbles. The resulting sheet was activated by exposure to an 365 nm Ultraviolet lamp. A section measuring 3 inches in diameter (7.6 cm) demonstrating uniform activated coloration and cosmetically acceptable appearance by the lack of visually detectable bubbles, non-uniform coloration, particles and voids was selected and cut out for further processing.

### Part B

The photochromic laminates from Part A were used in an injection molding process as described in Example 9 of U.S. Pat. No. 6,328,446, which Example 9 is specifically incorporated herein by reference, except that the finished lenses were not coated. In this process, the photochromic composite was first thermoformed to a 4-base curvature and then placed into the convex half of a 6 base bifocal lens mold having a diameter of 70 millimeters(mm) and a thickness of 12 mm. Vacuum was applied to pull the laminate into registry with the convex surface, the mold halves were closed and molten Lexan® polycarbonate was injected into the mold cavity. After cooling, the mold halves were separated and the resulting photochromic laminated lenses were tested for durability as described in Part F.

### Part C

The photochromic laminated films of Examples 1, 2 and 3 prepared in

Part A were tested for photochromic response as described herein on a Bench for Measuring Photochromics (BMP) optical bench made by Essilor, France.

Prior to testing on the optical bench, the photochromic laminated lenses were conditioned for photochromic response measurements by exposure to 365 nanometer ultraviolet light for about 10 minutes at a distance of about 14 centimeters to activate the photochromic compounds. The UVA (315 to 380 nm) irradiance at the sample was measured with a Licor Model Li-1800 spectroradiometer and found to be 22.2 watts per square meter. The lens samples were placed under a high intensity halogen lamp for about 10 minutes at a distance of about 36 centimeters to bleach (inactivate) the photochromic compounds. The illuminance at the sample was measured with the Licor spectroradiometer and found to be 21.9 Klux. The laminated lenses were then kept covered for at least 1 hour prior to testing on an optical bench.

The BMP comprises a flat metal surface to which was fitted two 150 watt Xenon arc lamps positioned 90° apart (one lamp to provide UV/VIS light and one to provide the additional contribution of visible light). The somewhat collimated output beams from the xenon arc lamps were combined and directed toward the sample cell and toward irradiance detectors through a 50/50 beam splitter. Each lamp was filtered and shuttered individually and also shuttered after blending, prior to entering the sample cell. Each lamp was filtered with a Schott 3 mm KG-2 band-pass filter. The lamp for supplemental visible light was additionally filtered with a 400 nm cutoff filter.

The software supplied with the equipment, i.e., BMPSoft version 2.1e, was used to control timing, irradiance, air cell and sample temperature, shuttering, filter selection and response measurement. The software program provided for irradiance adjustments within established set limits through a photofeedback unit, that in turn, made slight adjustments to the lamp wattage and subsequent lamp output. If a selected irradiance could not be achieved within the limits of the photofeedback unit, the program indicated the need for a change in selection of neutral density filters for each light path. Photopic response measurements were collected since multiple photochromic compounds were used in the laminate.

Set up of the BMP software required correlation factors between spectroradiometric measurements at the sample with a Licor Model 1800 spectroradiometer and a Graseby Model 5380 dual channel optometer fitted with a Model #268UVA UVA detector and a Model #268P visible light detector. The optometer detectors were mounted on an optical rail carrier and received one-half of the split and combined light beams from the xenon arc lamps. The BMP software used the correlation factors to set the operating irradiance on the optical bench. The lens sample cell was fitted with a quartz window and self-centering sample holder. The temperature in the sample cell was controlled at 23QC through the software with a modified Facis, Model FX-10, environment simulator.

The power output of the optical bench, e.g., the dosage of light that the sample lens would be exposed to, was adjusted to 6.7 Watts per square meter (W/m² of UVA). Visible light output was adjusted to 50 kilolux. A Zeiss spectrophotometer, Model MCS 501, with fiber optic cables for light delivery from a tungsten halogen lamp and through the sample was used for photochromic response and color measurements. The collimated monitoring light beam from the fiber optic cable was maintained perpendicular to the test sample while passing through the sample and directed into a receiving fiber optic cable assembly attached to the spectrophotometer. The exact point of placement of the sample in the sample cell was where the activating xenon arc beam and the monitoring light beam intersected to form two concentric circles of light. The angle of incidence of the xenon arc beam at the sample placement point was ≈20° from perpendicular.

Response measurements, in terms of a change in optical density (A OD) from the unactivated or bleached state to the activated or darkened state were determined by establishing the initial unactivated transmittance, opening the shutter from the Xenon lamp(s) and measuring the transmittance through activation at selected intervals of time. Change in optical density is determined according to the formula: ΔOD=log(% Tb/% Ta), where % Tb is the percent transmittance in the bleached state, % Ta is the percent transmittance in the activated state and the logarithm is to the base 10. Optical density measurement was done at the photopic wavelength and after 30 seconds and 15 minutes of activation.

The Fade Half Life (T ½) is the time interval in seconds for the ΔOD of the activated form of the photochromic materials in the sample lens to reach one half the ΔOD measured after fifteen minutes of activation at 23° C., after removal of the source of activating light, e.g., by closing the shutter. The Fade Half Life (T ½) measurement was done at the photopic wavelength. The results are reported in Table 1.

### Part D

The photochromic laminated films of Examples 1, 2 and 3 prepared in Part A were tested for the optical performance characteristics of percent haze and percent global transmission on Hunter Ultra Scan XE according to the Universal Software Version 3.1 User's Manual, Version 1.4, January, 1996 by Hunter Associates Laboratory, Inc. The results are listed in Table 2.

### Part E

The photochromic laminated lenses of Examples 1, 2 and 3 prepared in Part B were tested for adhesion using the Thumb Nail Test. Each of the lenses having the laminates prepared with Examples 1, 2 and 3 passed the test. The Thumb Nail Test comprises placing your thumb nail on the side of the lens in the area beneath the laminate in at least 5 different locations around the lens and attempting to pry it loose. Subsequently, the photochromic laminated lens were processed by Three Rivers Optical Laboratory in Pittsburgh in a typical optical laboratory process, known to those skilled in the art, by grinding the thickness of the lenses from 12 mm to a center thickness of 3 mm and cutting the size from a 70 mm diameter to a width of about 47 mm and height of about 35 mm to fit into frames. Each of the lenses were examined after processing and no delamination was observed. The photochromic laminates prepared with Examples 1, 2 and 3 were adherent to each of the lenses. The lenses were also examined for optical distortion by visually inspecting a grid of squares, each square measuring 1 cm by 1 cm in a grid on an 8½″×11″ sheet through each of the lenses by moving each lens in an up and down fashion about 2 feet away from the grid and held at arm's length and looking for any curvature in the grid which would indicate an optical distortion. Optical distortions were not observed for each of the lenses tested in this fashion.

TABLE 1

| | 23° C. | 23° C. | 23° C. |
|---|---|---|---|
| | ΔOD @ 30 | ΔOD @ 15 | (T ½) |
| Example No. | (seconds) | (minutes) | (seconds) |
| 1 | 0.68 | 0.98 | 97 |
| 2 | 0.63 | 0.94 | 97 |
| 3 | 0.63 | 0.91 | 94 |

TABLE 2

| | | Percent Global |
|---|---|---|
| Example No. | Percent Haze | Transmission |
| 1 | 0.6 | 78 |
| 2 | 0.8 | 85 |
| 3 | 0.7 | 79 |

The results of Tables 1 and 2 show that the films having the photochromic laminates prepared with Examples 1, 2 and 3 demonstrated acceptable photochromic properties of activation with a ΔOD @ 30 seconds from 0.63 to 0.68 and @ 15 minutes from 0.91 to 0.98 and of fade with a Fade Half Life of from 94 to 97 seconds and acceptable optical properties of from 0.6 to 0.8 percent haze and from 78 to 85 percent global transmission as measured on a BYK Gardner Haze-gard plus haze meter according to the procedure manual supplied.

Whereas particular embodiments of this invention have been described above for purposes of illustration, it will be evident to those skilled in the art that numerous variations of the details of the present invention may be made without departing from the invention as defined in the appended claims.

What is claimed is:

1. An optical element comprising:
a) a substrate;
b) an at least partial film of a photochromic adhesive comprising an at least partially adhesive material adapted to be thermoplastic and a photochromic amount of a photochromic material;
c) an at least partial film of a first polymeric organic material connected to said film of photochromic adhesive; and
d) an at least partial film of a second polymeric organic material, which is the same or different from said first polymeric organic material, interposed between said substrate and said partial film of photochromic adhesive, thereby to form an at least partial superstrate of a photochromic composite comprising said photochromic adhesive interposed between the films of the first and second polymeric organic materials; wherein said photochromic composite is sealed by securing edges of the film of said first polymeric material to edges of the film of said second polymeric material such that all of the photochromic adhesive interposed between the films of the first and second polymeric organic materials is kept in the photochromic composite.

2. The optical element of claim 1 wherein said adhesive material adapted to be thermoplastic is chosen from hotmelt adhesives, plastisol adhesives, heat-sealing adhesives, high-frequency sensitive heat-sealing adhesives, contact cements, pressure sensitive adhesives, aqueous emulsion adhesives, multi-purpose adhesives, solvent adhesives and mixtures thereof.

3. The optical element of claim 2 wherein said adhesive material adapted to be thermoplastic is a substantially thermoplastic adhesive and is chosen from hotmelt adhesives, contact cements, pressure sensitive adhesives, aqueous emulsion adhesives and mixtures thereof.

4. The optical element of claim 1 wherein said photochromic material is chosen from an inorganic photochromic material, an organic photochromic material and mixtures thereof.

5. The optical element of claim 4 wherein said photochromic material is an organic photochromic material and is chosen from pyrans, oxazines, fulgides, fulgimides, diarylethenes and mixtures thereof.

6. The optical element of claim 1 wherein said substrate is chosen from mineral glass, ceramic material and polymeric organic material and is an ophthalmic article.

7. The optical element of claim 6 wherein said ophthalmic article is a lens.

8. The optical element of claim 1 wherein said film of the first polymeric organic material is a material chosen from thermosetting materials, thermoplastic materials and mixtures thereof.

9. The optical element of claim 8 wherein said film of the first polymeric organic material is a thermoplastic material and is chosen from nylon, poly(vinyl acetate), vinyl chloride-vinyl acetate copolymer, poly (C₁-C₈ alkyl) acrylates, poly (C₁-C₈ alkyl) methacrylates, styrene-butadiene copolymer resin, poly(urea-urethane), polyurethane, polyterephthalate, polycarbonate, polycarbonate-silicone copolymer and mixtures thereof.

10. The optical element of claim 1 further comprising surface treatments chosen from protective films, at least partially polarizing surface treatments and combinations thereof connected to at least a portion of the substrate.

11. The optical element of claim 10 wherein said surface treatments are protective films chosen from protective sheet materials, protective gradient films, protective coatings and combinations thereof.

12. The optical element of claim 11 further comprising an at least partially antireflective surface treatment, an at least partially hydrophobic surface treatment or sequential surface treatments of said antireflective and said hydrophobic surface treatments superjacent to at least a portion of the surface of said optical element.

13. The optical element of claim 1 wherein said photochromic adhesive further comprises an at least partially adhesive material adapted to be thermosetting and a mixture of said adhesive materials adapted to be thermosetting and thermoplastic adhesives.

14. The optical element of claim 1 produced by a method comprising:
a) providing said substrate;
b) connecting said superstrate of a photochromic composite to a surface of said substrate under conditions such that said superstrate of a photochromic composite connects to the selected surface of the substrate.

15. The optical element of claim 14 wherein said method of providing said substrate and connecting said superstrate comprises:
i) providing said photochromic composite;
ii) providing an optical mold having a first and second surface, said first and second surfaces forming a cavity;
iii) placing said photochromic composite within the optical mold against said first surface of the optical mold, said photochromic composite having a size sufficient to cover a desired portion of the first surface;
iv) introducing polymerizable optical resin capable of forming an optical element into the cavity of the optical mold, and
v) at least partially curing said polymerizable optical resin, thereby to form an optical element having a first surface and a second surface and having said superstrate of a photochromic composite connected to said first surface of said optical element.

16. The optical element of claim 14 wherein edges of said photochromic composite are sealed by applying pressure and heat to the film of said first polymeric material and the film of said second polymeric material.
